(19) United States
(12) Patent Application Publication
(10) Pub. No.: US 2016/0358045 A1
(43) Pub. Date: Dec. 8, 2016

(54) ESTIMATING COLOR PLANE REGISTRATION

(71) Applicant: Hewlett-Packard Indigo B.V., Amstelveen (NL)

(72) Inventors: Nir GUTTMAN, Nes Ziona (IL); Yohanan SIVAN, Raanana (IL); Gregory BRAVERMAN, Nes Ziona (IL)

(21) Appl. No.: 15/118,928

(22) PCT Filed: Feb. 20, 2014
(86) PCT No.: PCT/EP2014/053375

§ 371 Date: Aug. 15, 2016

(51) Int. Cl. G06K 15/02; G01J 3/42; G01J 3/50; H04N 1/60

(52) U.S. Cl. CPC G06K 15/027; H04N 1/6008; H04N 1/6044; G01J 3/42; G01J 3/50; H04N 2201/0091

(57) ABSTRACT

In an example implementation, a processor-readable medium stores code representing instructions that when executed by a processor cause a plurality of patches to be printed onto a substrate. Each patch comprises a first colored line and a second colored line that are parallel to one another and separated by a distance X. For each patch, a measured reflection value is received and mapped to a curve as a function of X. A color plane registration value is then estimated by interpolating a maximum reflection value between the two highest measured reflection values on the curve.

### BACKGROUND

Imaging devices such as printers and copiers employ various techniques to deposit ink or powdered toner onto paper or other print substrate to produce a printed product. Such devices are often configured to produce both monochromatic and multi-colored images. Devices having multi-color capability often use cyan, magenta, yellow and black (CMYK) color separations to produce images that can comprise a large color gamut space. In some devices, a photoconductive surface is used to develop hardcopies of images. The photoconductive surface is selectively charged with a latent electrostatic image having image and background areas. A developer that includes charged ink or toner particles in a carrier liquid is brought into contact with the selectively charged photoconductive surface, and the ink or toner particles adhere to the image areas of the latent image while the background areas remain clean. Paper or other print substrate is then brought directly or indirectly into contact with the photoconductive surface in order to transfer the latent image.

In a multi-color printing process, this image formation process is performed separately for each of the colors to produce the finished image. Each image comprises a single color separation referred to as a “color plane,” and the color planes are brought together to form the finished image. A finished image may not be formed of all the available colors, but instead may be formed of any one or combination of the available colors. Where multiple colors are used, however, the quality of the finished image depends on how well the color planes are aligned with one another. The alignment of color planes is referred to as “color plane registration”, and images having misregistered (i.e., misaligned) color planes can appear to lack sharpness and/or be unclear, or have other anomalies such as a noticeable color shift in the printed color.

### BRIEF DESCRIPTION OF THE DRAWINGS

The present embodiments will now be described, by way of example, with reference to the accompanying drawings, in which:

FIG. 1 shows an example of a printing device that is suitable for calibrating color plane registration of the device using reflection values measured from patches printed with two color separations;

FIG. 2 shows a box diagram of a controller suitable for controlling a print engine to generate printed substrate and implementing a color plane registration algorithm;

FIG. 3 shows another example of a printing device that is suitable for calibrating color plane registration of the device using reflection values measured from patches printed with two color separations;

FIG. 4 shows examples of portions of three printed patches on a printed substrate;

FIG. 5 shows an example of a digital pattern next to an example of part of the patch that is printed from the digital pattern;

FIG. 6 shows an example of a registration image comprising a plurality of digital patches;

FIG. 7 shows an example of a graph with reflections measured across a spectrum of wavelengths for a number of printed patches;

FIG. 8 shows an example of single reflection values for each printed patch resulting from the integration of the reflections across a spectrum of wavelengths shown in FIG. 7;

FIG. 9 shows an example flowchart of an example method related to a color plane registration algorithm for calibrating a color plane registration of a printing device.

Throughout the drawings, identical reference numbers designate similar, but not necessarily identical, elements.

### DETAILED DESCRIPTION

### Overview

Misregistration between color separations, or color planes, in multi-color printing systems can be caused by a variety of mostly mechanical factors. These factors include characteristics of the print engine such as the timing and coordination of lasers and photoconductors that form an image on a print substrate. Calibrating a printing system's color plane registration involves characterizing existing misregistration between the color planes. Once the color plane misregistration is properly characterized, appropriate adjustments can be made within the print engine to correctly register the color planes.

Prior methods of characterizing color plane misregistration typically involve the use of physical registration marks that include two straight lines. Each line is formed with a different color separation, and the lines are joined together to form a single straight line. The single line is then examined visually through a microscope, for example, or by using a high resolution scanning device and complex software, to determine if the two lines are properly aligned to form the single straight line. A misalignment indicates misregistration between the color separations. While these methods enable adequate calibration of a print system's color plane registration, performing the visual examinations can be tedious and time consuming, while the high resolution scanning equipment and computer analysis can be expensive and prone to error caused by small defects such as ink or toner splatters.

Another prior method of characterizing color plane misregistration involves measuring the transition time between the edges of chevron shaped registration marks of two color separations (e.g., cyan and magenta) on an image bearing surface as the surface moves in its process direction. Photo detectors measure the time between the moving edges of the chevrons, which can then be used to compute the misregistration in both slow and fast scan directions. Unfortunately, having photo detectors placed in more than two or three locations across the width of the image bearing surface is not practical. Therefore, using this method results in limited misregistration measurements that cover only partial areas of the image bearing surface. Furthermore, due to the significant expense of the photo detectors and associated software used to analyze and process the images, the use of this method is typically limited to high-end printing systems.

The present disclosure is directed to a system that calibrates a color plane registration of a printing device using reflection values measured from printed patches. The system estimates a color plane registration value by measuring and comparing reflection values from patches that are printed in two color separations. Misregistration between the color planes is characterized by mapping the reflection value for each patch onto a curve. Characteristics of the resultant curve are used to interpolate an estimated maximum reflection value, which is in turn used to estimate a color plane registration value. The estimated color plane registration value provides an indication of the degree of registration present between the color planes, which enables a calibration of the system's color plane registration through adjusting certain components and/or parameters of the system's print engine. The disclosed system enables real time (i.e., during printing) measurements and analysis that provide an estimated color plane registration value. The analysis is minimized to reduce the processing load, yet is robust in that it is not sensitive to substrate type or the consistency of the colors printed on the measured patches.

In one example, a processor-readable medium stores code representing instructions that when executed by a processor cause a plurality of patches to be printed onto a substrate. Each patch comprises a first colored line and a second colored line that are parallel to one another and separated by a distance X. For each patch, a measured reflection value is received and mapped to a curve as a function of X. A color plane registration value is then estimated by interpolating a maximum reflection value between the two highest measured reflection values on the curve.

In another example, a processor-readable medium stores code representing instructions that when executed by a processor cause the processor to print a series of patches on a substrate, with each patch having two parallel lines of different colors separated by a registration amount that is different for each patch. The processor further measures a reflection value of each patch with a spectrophotometer and maps the reflection value of each patch as a function of its registration amount. The processor estimates a maximum reflection value between two highest measured reflection values using a straight line interpolation.

In another example, a printing device includes a print engine to print a series of patches on a substrate, and a spectral measurement device to measure reflection values and corresponding registration displacements from the patches. The printing device also includes an algorithm to estimate a maximum reflection value based on a linear interpolation of the measured reflection values.

### Illustrative Embodiments

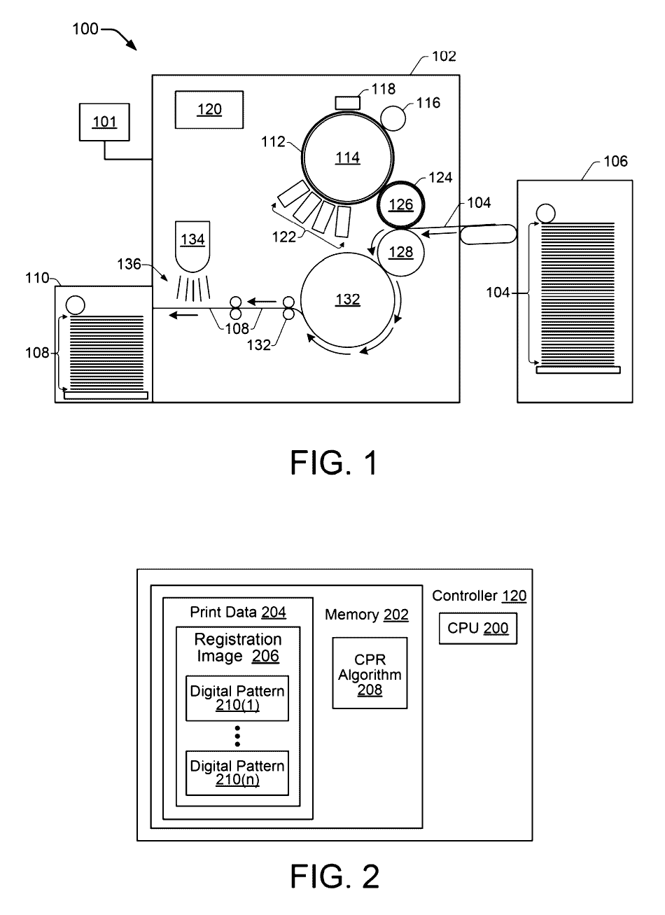

FIGS. 1 and 3 illustrate examples of a printing device 100 that is suitable for calibrating color plane registration of the device 100 using reflection values measured from patches printed with two color separations. The printing device 100 comprises a print-on-demand device such liquid electro-photography (LEP) printing press. A printing device 100 implemented as an LEP printing press 100 generally includes a user interface 101 that enables an operator to manage various aspects of printing, such as loading and reviewing print jobs, proofing and color matching print jobs, transferring approved print jobs to an approved print queue for printing, reviewing the order of the print jobs, handling media substrates, and so on. The user interface 101 typically includes a touch-sensitive display screen that allows the operator to interact with information on the screen, make entries on the screen, and generally control the press 100. A user interface 101 may also include other devices such as a key pad, a keyboard a mouse, and a joystick, for example.

An LEP printing press 100 includes a print engine 102 that receives print media/substrate 104 from one or more media input mechanisms 106, and outputs printed media/substrate 108 to one or more media output mechanisms, such as output stacker tray 110. Print media 104 can be in various forms including cut-sheet paper 104 from a stacked media input mechanism 106 as shown in FIG. 1, or a media web 104 from a media paper roll input mechanism 106 as shown in FIG. 3. In general, the print engine 102 generates printed media/substrate 108 in the form of printed jobs and printed image patch sheets. The print engine 102 outputs the printed substrate 108 to an output stacker tray 110. In some implementations printed jobs may be output to an output stacker tray 10 while printed image patch sheets are output to a separate sample tray (not shown). When the printed substrate 108 is a media web as shown in FIG. 3, one or more finishing devices 111 may be employed to cut the printed media web into sheets prior to it being stacked in an output stacker tray 110. Alternatively, the printed media web may not be cut into sheets and stacked, but instead may be output to a media output roll (not shown).

As shown in FIGS. 1 and 3, an example LEP printing press 100 also includes a spectral measurement device 134 to measure the reflection of individual image patches printed onto a printed substrate 108. A light source (not shown) may accompany the spectral measurement device 134 to provide light for reflecting off the printed substrate 108. The spectral measurement device 134 can be implemented, for example, as a spectrometer, spectrophotometer, spectrograph, spectral analyzer, or other suitable device. Thus, while the spectral measurement device 134 is primarily referred to herein as a spectrophotometer 134, other devices that operate in the same or similar manner to measure a reflection spectrum from printed substrate 108 may also be appropriate. In general, a spectrophotometer 134 operates to measure the intensity of radiation (i.e., light) 136 reflecting off of a printed substrate 108 as a function of its wavelength or frequency. More specifically, the spectrophotometer 134 quantitatively measures the amount or intensity of light reflecting off of a printed substrate 108 across a range of wavelengths and at certain wavelength intervals. The range of wavelengths measured can vary, but in one example the wavelengths measured make up colors of the visible spectrum within the range of 380 to 750 nanometers (nm). An example of an interval over which wavelengths are measured is 10 nm. Thus, the spectrophotometer 134 may measure the amount of light reflected off of a printed substrate 108 for wavelengths within a range of 380 and 750 nm, with reflection measurements being taken at 10 nm intervals within that range. The intensity of reflected light at each wavelength interval can be measured and quantified as the number of photons being detected per second (e.g., using a photodiode, charge coupled device, or other light sensor). This photon flux density is typically expressed as watts per meter squared.

The print engine 102 includes a photo imaging component, such as a photo imaging plate (PIP) 112 mounted on a drum or imaging cylinder 114. The PIP 112 defines an outer surface of the imaging cylinder 114 on which images can be formed. A charging component such as charge roller 116 generates electrical charge that flows toward the PIP surface, and covers it with a uniform electrostatic charge. A laser imaging unit 118 exposes image areas on the PIP 112 by dissipating (neutralizing) the charge in those areas. Exposure of the PIP creates a ‘latent image’ in the form of an invisible electrostatic charge pattern that replicates the image to be printed.

After the latent/electrostatic image is formed on the PIP 112 the image is developed by a binary ink development (BID) roller 122 to form an ink image on the outer surface of the PIP 112. Each BID roller 122 develops a single ink color (i.e., a single color separation) of the image, and each developed color separation corresponds with one image impression. While four BID rollers 122 are shown, indicating a four color process (i.e., C, M, Y, and K), other press implementations may include additional BID rollers 122 corresponding to additional colors. After a single color separation impression of an image is developed onto the PIP 112, it is electrically transferred from the PIP 112 to an image transfer blanket 124, which is electrically charged through an intermediate drum or transfer cylinder 126. The image transfer blanket 124 overlies, and is securely attached to, the outer surface of the transfer cylinder 106. The transfer cylinder 126 is configured to heat the blanket 124, which causes the liquid in the ink to evaporate and the solid particles to partially melt and blend together, forming a hot adhesive liquid plastic that can be transferred to a print substrate 104.

In the case of a printing device 100 that s a print substrate 104 comprising cut-sheet paper from a stacked media input mechanism 106, as shown in FIG. 1, a single color separation impression of an image is transferred from the image transfer blanket 24 to a sheet of the print substrate 104 held by an impression cylinder 128 The above process of developing image impressions and transferring them to the sheet of print substrate 104 is then repeated for each, color separation of the image. The sheet of print substrate 104 remains on the impression cylinder 128 until all the color separation impressions (e.g., C, M, Y, and K) in the image have been transferred to the sheet. After all the color impressions have been transferred to the sheet of print substrate 104, the printed substrate 108 sheet comprises the full image. The printed substrate 108 sheet with the full image is then transported by various rollers 132 from the impression cylinder 128 to the output mechanism 110.

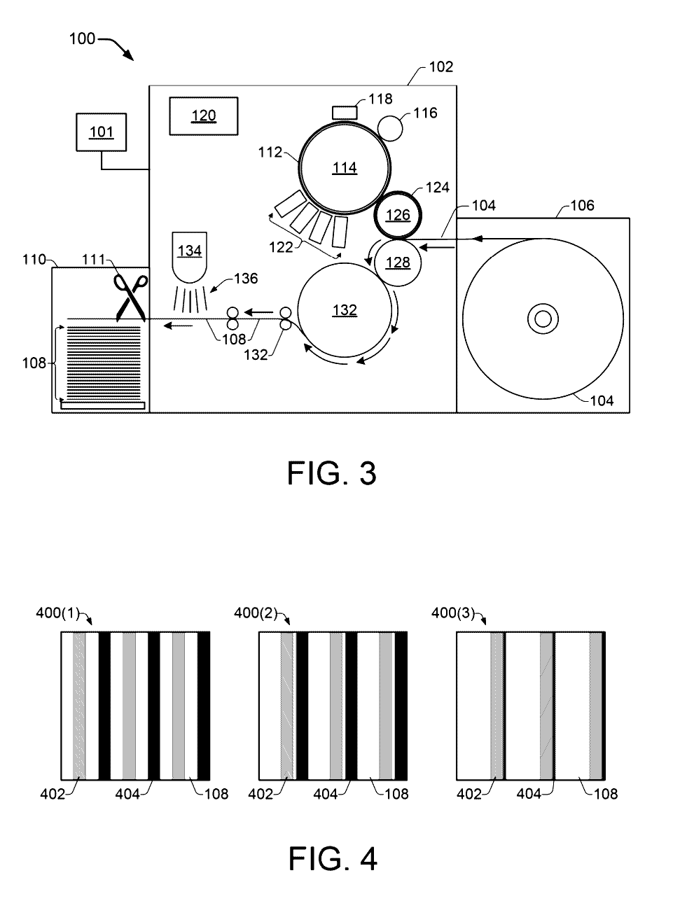

In the case of a printing device 100 that uses a print substrate 104 comprising a media web from a media paper roll input mechanism 106, as shown in FIG. 2, the different color separations (e.g., C, V, and K) of an image are transferred together from the image transfer blanket 124 to the web of print substrate 104. Thus, the full image is built up on the blanket 124 prior to being transferred to the print substrate 104. Here, the imaging process involves transferring, each color separation from the PIP 112 to the image transfer blanket 124 until all the color separations making up the full image are present on the transfer blanket 124. Once all the color separations forming the full image have been transferred onto the image transfer blanket 124, the inks for all the color separations are heated on the blanket 124, and the full image is transferred from the blanket 124 to the web of print substrate 104. The printed substrate 108 web with the full image is then transported by various rollers 132 to the output mechanism 110 where typically cut and stacked, or rolled onto an output media roll.

In a digital LEP printing device 100, images are created from digital image data that represents words, pages, text and images that can be created, for example, with electronic layout and/or desktop publishing programs, cameras, scanners, and so on. A controller 120 uses the digital image data to control components of the print engine 102 during the printing process to generate printed media/substrate 108, such as controlling the laser imaging unit 118 to selectively expose the PIP 112. Digital image data is generally formatted as one or more print jobs stored and executed on controller 120, as further discussed below. In addition to controlling the printing process, controller 120 controls the operation of the spectrophotometer 134 and implements a color plane registration algorithm to calibrate the color plane registration of the printing device 100 using an estimated registration value derived from spectral reflections measured from printed patches.

FIG. 2 shows a box diagram of a controller 120 suitable for controlling a print engine 102 to generate printed media/substrate 108, and for implementing a color plane registration (CPR) algorithm to calibrate the color plane registration of a printing device 100. Controller 120 generally comprises a processor (CPU) 200 and a memory 202, and may additionally include firmware and other electronics for communicating with and controlling the components of print engine 102, such as the user interface 101 and the media input (106) and output (110) mechanisms. Memory 202 can include both volatile (i.e., RAM) and nonvolatile (e.g., ROM, hard disk, floppy disk, CD-ROM, etc.) memory components comprising non-transitory computer/processor-readable media that provide for the storage of computer/processor-readable coded instructions, data structures, program modules, JDF (job definition format), and other data.

As noted above, controller 120 uses digital image data to control the laser imaging unit 118 in the print engine 102 to selectively expose the PIP 112. More specifically, controller 120 receives print data 204 from a host system, such as a computer, and stores the data 204 in memory 202. Data 204 represents, for example, documents or image files to be printed. As such, data 204 forms one or more print jobs for printing device 100 that each include print job commands and/or command parameters. Using a print job from data 204, controller 120 controls components of print engine 102 (e.g., laser imaging unit 118) to form characters, symbols, and/or other graphics or images on print media/substrate 104.

In one implementation, data 204 includes a print job in the form of a registration image 206 and the controller 120 includes a color plane registration (CPR) algorithm 208 stored in memory 202. The CPR algorithm 208 comprises instructions executable on processor 200 to calibrate the color plane registration of printing device 100. During printing, at a scheduled interval, and/or upon receiving a user instruction via the user interface 101, the CPR algorithm 208 executes to initiate a color plane registration calibration. The algorithm 208 calibrates the color plane registration by estimating a registration value based on spectral reflection values measured from patches printed on a printed substrate 108. The measured patches are printed from, and correspond with, a plurality of digital patterns 210(1-n), from a registration image 206 (FIG. 2).

FIG. 4 shows example portions of three printed patches 400(1-3) on a printed substrate 108, Note that each of the printed patches 400(1-3) shown represent just a portion of a larger printed patch that repeats a pattern of parallel lines many times to create a measurable patch. Thus, the size of the printed patches 400(1-3) showing the line patterns is on the order of microns, while the size of an actual full printed patch is on the order of centimeters. Each of the printed patches 400(1-3) has parallel lines 402 and 404, printed on the substrate 108 that alternate between two color separations (e.g., cyan and magenta). Thus, lines 402 are printed in a first color, and lines 404 are printed in a second color. The printed patches 400(1-3) are printed from corresponding digital patterns 210(1-3) in a registration image 206. Thus, printed patch 400(1) comprises the printed manifestation of a digital pattern 210(1) from registration Mage 206, printed patch 400(2) comprises the printed manifestation of a digital pattern 210(2) from registration image 206, and printed patch 400(3) comprises the printed manifestation of a digital pattern 210(3) from registration image 206. Of the three punted patches 400(1-3), the color separation lines 402 and 404 in printed patch 400(3) are the closest to being directly on top of one another (i.e., are the most closely aligned). Thus, compared to printed patches 400(1) and 400(2), the printed patch 400(3) represents a color plane registration value that is the closest to being properly calibrated. In addition, of the three printed patches 400(1-3), printed patch 400(3) has the largest visible fraction of printed substrate 108 (i.e., the least amount of the printed substrate 108 being covered with ink). Printed patches whose parallel lines 402 and 404 intersect one another have greater visible portions of printed substrate 108 (i.e., lesser amounts of printed substrate 108 covered with ink), which produces higher reflection values when measured by the spectrophotometer 134. Greater intersection or alignment between the parallel lines 402 and 404 means there is less ink area on printed substrate 108 available to absorb wavelengths of light, and greater visible area of printed substrate 108 available to reflect light. Thus, the highest reflection value occurs when the parallel lines 402 and 404, printed with different color separations, are fully aligned. Accordingly, the best calibration of the color plane registration corresponds with the highest reflection value measured from the printed patches.

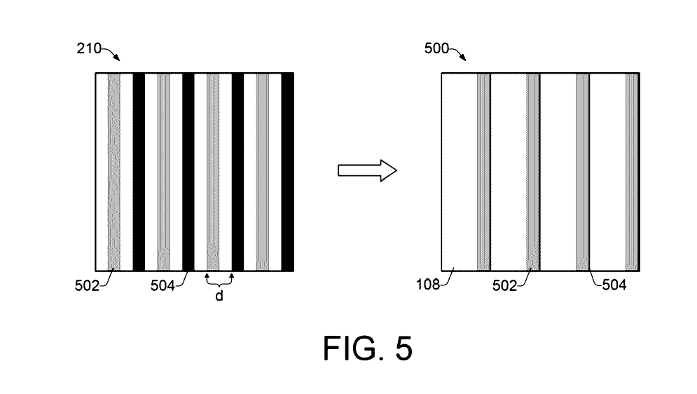

FIG. 5 shows an example of a digital pattern 210 from a registration image 206 (FIG. 2) placed next to an example portion of a patch printed on a substrate 108 that corresponds to the digital pattern 210. In other words, FIG. 5 shows a digital pattern 210 that has been printed onto a substrate 108 as printed patch 500, which is part of a larger patch. Thus, the printed patch 500 shown in FIG. 5 represents just a portion of a larger printed patch that repeats the digital pattern 214 many times to create a measurable patch. The size of the printed patch 500 showing the line patterns is, on the order of microns, while the size of an actual full printed patch is on the order of centimeters. The parallel lines, 502 and 504, on both patches are of two color separations (e.g., cyan and magenta). Thus, lines 502 are of a first color, and lines 504 are of a second color. If the color plane registration of printing device 100 is properly calibrated, the printed patch 500 should appear the same as the digital pattern 210. Therefore, with a properly calibrated color plane registration, the different colored lines 502 and 504 on the printed patch 500 should be separated by the same displacement “d” that separates the different colored lines 502 and 504 in the digital pattern 210. However, because the lines 502 and 504 in the printed patch 500 are not displaced by an amount “d”, but instead are printed directly on top of one another, it is apparent that the color planes of printing device 100 are mis-registered by the displacement amount “d”. Similarly, if lines 502 and 504 were directly on top of one another (i.e., perfectly aligned) in the digital pattern 210 but were displaced on the printed patch 500 by an amount “d” or by some other displacement, then it would be clear that the color plane registration is off (i.e., “mis-registered”) by an amount equal to that displacement

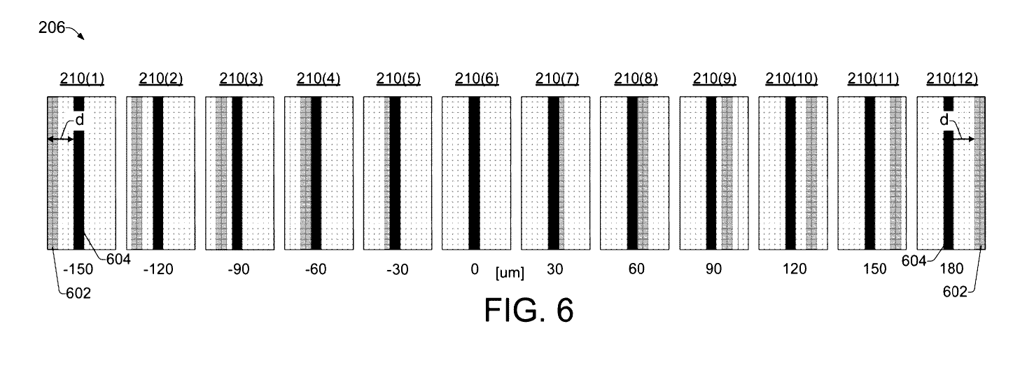

FIG. 6 shows an example of a registration image 206 (FIG. 2) comprising a plurality of digital patterns 210(1-12). The patterns 210(1-12) are configured as a strip of nearby patches, positioned one after another. Each digital pattern 210(1-12) has two parallel lines in two color separations, 602 and 604 (e.g., cyan and magenta). That is, lines 602 are of a first color, and lines 604 are of a second color. For the purpose of illustration, the digital patterns 210(1-12) include pixel gridlines that show the division of pixels that make up a portion of each patch that will be printed. Thus, each pattern 210 and partial patch printed from that pattern covers an area thirteen pixels wide by twenty-five pixels high, and each of the lines, 602 and 604, cover an area two pixels wide by twenty-five pixels high. The lines 602 and 604 in each digital pattern 210(1-12) are separated by a displacement “d”, which is indicated in microns (μm) below each pattern. The displacement “d” is the distance from the left most pixel in line 604 to the left most pixel in line 602, for each pattern. Therefore, referring to digital pattern 210(1), the separation displacement “d” spans 5 pixel widths and is equal to −156 microns. Similarly, referring to digital pattern 210(12), the displacement spans 6 pixel widths and is equal to 180 microns. Accordingly, in this example, the pixel resolution of the print engine 102 is 30 microns. As generally noted above, when digital patterns 210(1-12) are printed by a printing device 100 with properly calibrated color plane registration the displacement “d” in each, portion of printed patch between lines 6 and 604 will match that of the corresponding digital pattern. Thus, a patch printed from digital pattern 210(1), will have a displacement equal to −150 microns.

Referring to FIG. 6, it is noted that while the registration image 206 is described as comprising twelve digital patterns 210(1-12), there is no intent to limit the registration image 206 to a particular number of digital patterns 210. Thus, in other implementations of a printing device 100, a registration image 206 may comprise a greater or lesser number of digital patterns 210. Furthermore, the digital patterns 210 and lines 602 and 604 have been described as comprising a certain number and area of pixels, the patterns and lines are not limited in this regard. Accordingly, digital patterns 210 and lines 602 and 604 used in other implementations may have a different number and configuration of pixels. In addition, while the pixel resolution of the print engine 102 is indicated to be 30 microns, the principles discussed herein are not limited in their application to printing devices having a particular pixel resolution.

As noted above in the discussion of FIGS. 4 and 5, a calibrated color plane registration corresponds with a printed patch having the highest measured reflection value, and the highest reflection value occurs in the patch in which the different colored parallel lines are fully aligned. The lines are fully aligned when there is no displacement between lines of one color and lines of another color, which is when the line or lines of one color are directly on top of the line or lines of the other color, Referring, then to FIG. 6, for a printing device 100 with a properly calibrated color plane registration, a printed patch (not shown) that corresponds to digital pattern 210(6) will provide the highest reflection value, because there is zero displacement between the colored lines in digital pattern 210(6). However, as discussed above, when the color plane is not properly calibrated (i.e., mis-registered), the displacement of the colored lines in a printed patch will be different than in its corresponding digital pattern. Therefore, the highest reflection value will not correspond with the zero-displacement digital pattern 210(6) in FIG. 6.

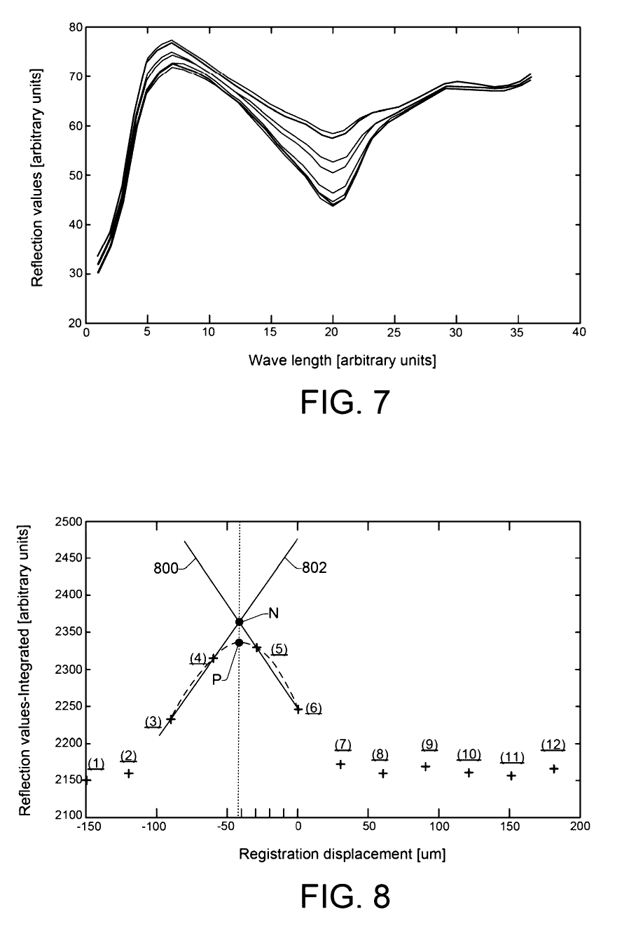

This point is illustrated more clearly in FIGS. 7 and 8. The example graphs in FIGS. 7 and 8 represent reflection values measured by a spectrophotometer 134 of printed patches (not shown) that correspond with the digital patterns 210 (1-12) of FIG. 6. Each line in the FIG. 7 graph shows reflections (y-axis) measured across a spectrum of wavelengths (x-axis) for a printed patch that corresponds with a digital pattern 210(1-12). Each reflection value, (1)-(12), mapped on the FIG. 8 graph is an integration of the reflections along a single line from the FIG. 7 graph. The reflection values in FIG. 8 (y-axis) are mapped as a function of the displacement amounts (x-axis) measured between lines 602 and 604 of a printed patch (not shown). Therefore, point (2) on the graph of FIG. 8 corresponds with digital pattern 210(2) in FIG. 6, point (3) on the graph of FIG. 8 corresponds with digital pattern 210(3) in FIG. 6, and so on.

Referring to FIG. 8 the color plane registration of a printing device 100 is properly calibrated at the point where the measured reflection value is highest, which should occur when the registration displacement is zero. From the graph of FIG. 8, it is apparent that the highest reflection value is somewhere between measured reflection values at points (4) and (5), which occurs at a registration displacement of approximately −41 microns. Therefore, it is clear that the amount of color plane nits-registration in the printing device 100 is approximately −41 microns. The color plane registration of the printing device 100 can be calibrated to correct the mis-registration by making adjustments to the print engine. This can include, for example, adjusting various parameters of the print engine such as the timing and coordination of the laser imaging unit 118 with respect to the photo imaging plate (PIP) 112, and so on.

Referring to the graph of FIG. 8, the maximum reflection value between the highest measured reflection values at points (4) and (5), can be estimated by interpolation from the available measured reflection values at points (1)-(12). For example, a parabolic interpolation between the two highest points, (4) and (5), can be performed using a quadratic function (or some other appropriate mathematical function) to estimate the maximum reflection point (P) along a parabolic line between points (4) and (5).

However, there are more accurate models available to estimate the maximum reflection value. One such model is the Neugebauer model, which assumes a linear dependence between the spectrum and the printed patch location. The Neugebauer model estimates the maximum reflection value at point (N) using straight lines, such as straight lines 800 and 802 that pass through the highest measured reflection values at points (5) and (4), respectively, as shown in FIG. 8. The Neugebauer model estimates the maximum reflection value using a linear interpolation based on the following equation:

R=Rw*(Awi+X)+Rc*(Aci−X)+Rm*(Ami−X)+Rcm*(Acmi+X)=A+B*X (eq.1)

In (eq.1), it is assumed that a printed patch has two color separations, comprising vertical or horizontal lines of color 1 and color 2 and of a certain width. The lines of color 1 are separated by a constant length, and the lines of color 2 are separated by the same constant length. The digital positions of the lines of color 1 and color 2 with respect to each other are represented by a measurable registration displacement value of X. In a series of nearby patches. each patch has a different value of X, and a reflection value measured by a spectrophotometer for each patch can be mapped on curve as a function of X. As X approaches zero for any patch, the measured reflection value will be the highest. This is because when X is zero, the color lines are aligned directly on top of one another (i.e., the color planes are properly registered), resulting in a greater fraction of visible substrate available to reflect light (i.e., less of the substrate is covered by printed colors), Therefore, the color plane registration is properly calibrated at the X displacement value that corresponds with the highest reflection value on the curve.

Referring to FIG. 8, and relying on the Neugebauer model of (eq.1), an estimation of the calibrated registration value X is determined based on a linear interpolation between the maximal reflection data point and the two data points (4) and (5), surrounding it. According to the Neugebauer model presented in (eq.1), the reflection (R) is equal to the sum of the reflection of the different inks (R_{c}, Rₘ, R_{cm}) and substrate (R_{w}), where each ink reflection contribution and substrate reflection contribution is weighted according to its physical area (Ac, Am, Acm) and (Aw), respectively. The registration value X modifies the contribution weight in the same amount for all inks and substrate.

Equation 1 (eq.1), is an example for a specific case where the subscripts w, c, m, and cm stand for the substrates, cyan, magenta, and cyan-magenta, respectively. The right hand side of (eq.1) shows that the total reflection is a linear function of the registration value X.

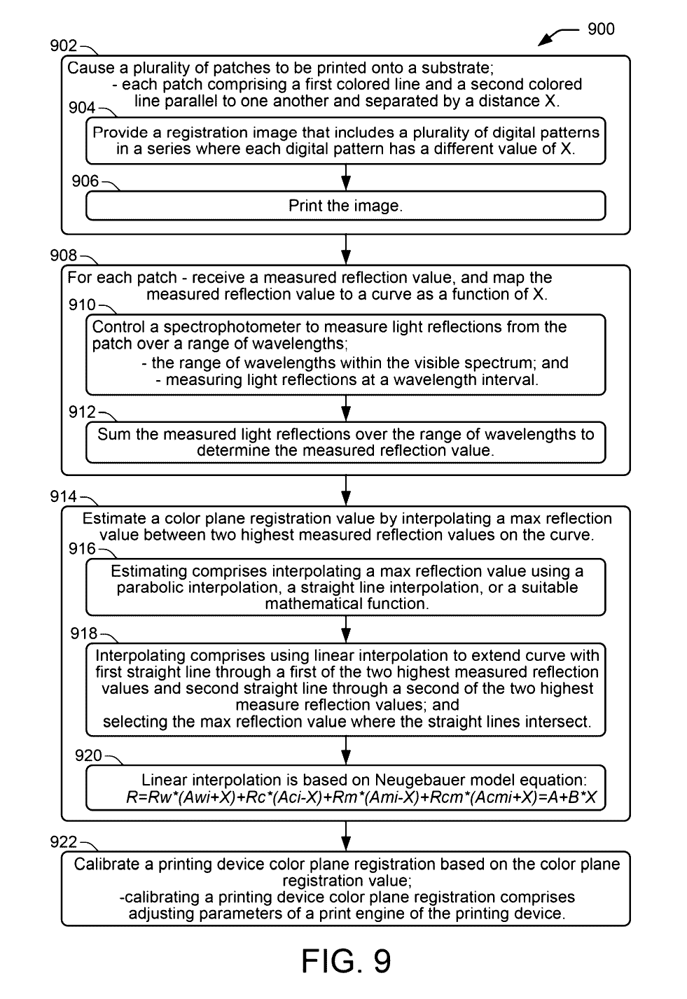

FIG. 9 shows a flowchart of an example method 900, related to a color plane registration (CPR) algorithm 208 comprising instructions executable on a processor 200 to calibrate the color plane registration of a printing device 100. Method 900 is associated with the example implementations discussed above with regard to FIGS. 1-8, and details of the steps shown in method 900 can be found in the related discussion of such implementations. The steps of method 900 may be embodied as programming instructions stored on a non-transitory computer/processor-readable medium, such as memory 202 of FIG. 2. In different examples, the implementation of the steps of method 900, is achieved by the reading and execution of such programming instructions by a processor, such as processor 200 of FIG. 2. Method 900 may include more than one implementation, and different implementations of method 900 may not employ every step presented in the flowchart. Therefore, while steps of method 900 are presented in a particular order within the flowchart, the order of their presentation is not intended to be a limitation as to the order in which the steps may actually be implemented, or as to whether all of the steps may be implemented. For example, one implementation of method 900 might be achieved through the performance of a number of initial steps, without performing one or more subsequent steps, while another implementation of method 900 might be achieved through the performance of all of the steps.

Method 900 begins at block 902, where the first step shown is to cause a plurality of patches to be printed onto a substrate. Each of the patches comprises a first colored line and a second colored line that are parallel to one another and separated by a distance X. Causing the patches to be printed comprises providing a registration image that includes a plurality of digital patterns in a series as shown at block 904. Each digital pattern has a different value of X. As shown at block 906, the image is then printed.

The method 900 continues at block 908 with receiving a measured reflection value for each printed patch, and mapping the measured reflection value to a curve as a function of X. Receiving a measured reflection value for each printed patch includes controlling a spectrophotometer to measure light reflections from the patch over a range of wavelengths, as shown at block 910, and summing the measured light reflections over the range of wavelengths to determine the measured reflection value, as shown at block 912. In one example, reflections are measured at wavelength intervals, and the range of wavelengths over which the intervals occur is within the visible spectrum.

At block 914 of method 900, a color plane registration value is estimated by interpolating a maximum reflection value between the two highest measured reflection values on the curve. The estimation comprises interpolating the maximum reflection value using a parabolic interpolation or a straight line interpolation, or other suitable mathematical function, as shown at block 916. In one example shown at block 918, interpolating comprises using a linear or straight line interpolation to extend the curve with a first straight line through a first of the two highest measured reflection values, and with a second straight line through a second of the two highest measure reflection values. Then the maximum reflection value is selected at the point where the straight lines intersect. In one example, as shown at block 920, the linear interpolation is based on the Neugebauer model equation, discussed in greater detail above:

R=Rw*(Awi+X)+Rc*(Aci−X)+Rm*(Ami−X)+Rcm*(Acmi+X)=A+B*X (eq.1)

The method 900 continues at block 922 with calibrating a printing device color plane registration based on the color plane, registration value. The calibration includes adjusting parameters of a print engine of the printing device.

What is claimed is:

1. A non-transitory processor-readable medium storing code representing instructions that when executed by a processor cause the processor to:
a plurality of patches to be printed onto a substrate, each patch comprising a first colored line and a second colored line that are parallel to one another and separated by a distance X;
for each patch, receive a measured reflection value, and map the measured reflection value to a curve as a function of X; and
estimate a color plane registration value by interpolating a maximum reflection value between two highest measured reflection values on the curve.

2. A medium as in claim 1, wherein causing a plurality of patches to be printed onto a substrate comprises:
providing a registration image that includes a plurality of digital patches in a series where each digital patch has a different value of X; and
printing the image.

3. A medium as in claim 1, wherein receiving a measured reflection value or each patch comprises:
controlling a spectrophotometer to measure light reflections from the patch over a range of wavelengths; and
summing the measured light reflections over the range of wavelengths to determine the measured reflection value.

4. A medium as in claim 3, wherein:
the range of wavelengths comprises wavelengths within the visible spectrum; and
measuring light reflections comprises measuring light reflections at a wavelength interval.

5. A medium as in claim 1, wherein estimating a color plane registration value comprises interpolating a maximum reflection value using an interpolation selected from the group consisting of a parabolic interpolation, a straight line interpolation, and a suitable mathematical function.

6. A medium as in claim 1, wherein interpolating a maximum reflection value comprises:
using a linear interpolation to extend the curve with a first straight line through a first of the two highest measured reflection values and a second straight line through a second of the two highest measure reflection values; and
selecting the maximum reflection value where the straight lines intersect.

7. A medium as in claim 6, wherein the linear interpolation is based on Neugebauer model using the following equation:
R=Rw*(Awi+X)+Rc*(Aci−X)+Rm*(Ami−X)+Rcm*(Acmi+X)=A+B*X;
wherein R is the reflection value, X is a registration value, Rc, Rm, and Rcm are reflection values of different colored inks; w is white substrate, Ac, Am, Acm, and Aw, are physical areas of different colored inks and white substrate, respectively, and c, m and cm correspond respectively with cyan, magenta and cyan-magenta ink colors.

8. A medium as in claim 1, the instructions further causing the processor to:
calibrate a printing device color plane registration based on the color plane registration value.

9. A medium as in claim 1, wherein calibrating a printing device color plane registration comprises adjusting parameters of a print engine of the printing device.

10. A non-transitory processor-readable medium storing code representing instructions that when executed by a processor cause the processor to:
print a series of patches on a substrate, each patch having two parallel lines of different colors separated by a registration amount, wherein the registration amount is different for each patch;
measure a reflection value of each patch with a spectrophotometer;
map the reflection value of each patch as a function of its registration amount;
estimate a maximum reflection value between two highest measured reflection values through a straight line interpolation.

11. A medium as in claim 10, wherein the straight line interpolation is based on a Neugebauer model.

12. A printing device comprising:
a print engine to print a series of patches on a substrate;
a spectral measurement device to measure reflection values and corresponding registration displacements from the patches; and
an algorithm to estimate a maximum reflection value based on a linear interpolation of the measured reflection values.

13. A printing device as in claim 12, wherein the algorithm is further to determine a registration that corresponds with the maximum reflection value, and to adjust parameters of a print engine according to the registration.

14. A printing device as in claim 12, wherein each patch comprise parallel lines of different colors, separated by a registration displacement.

15. A printing device as in claim 12, wherein the substrate is selected from the group consisting of a media web and a cut sheet.

16. A printing device as in claim 12, wherein the spectral measurement device comprises a spectrophotometer.
